(19) United States
(12) Patent Application Publication
(10) Pub. No.: US 2012/0247865 A1
(43) Pub. Date: Oct. 4, 2012

(54) PORTABLE SEISMIC COMMUNICATION DEVICE

(76) Inventor: Michael Kim McCarter, Sandy, UT (US)

(21) Appl. No.: 13/411,104

(22) Filed: Mar. 2, 2012

Related U.S. Application Data
(60) Provisional application No. 61/448,976, filed on Mar. 3, 2011.

(30) Foreign Application Priority Data
Nov. 11, 2011 (CL) 2829-2011

(51) Int. Cl. G10K 15/00

(52) U.S. Cl. 181/142

(57) ABSTRACT

A portable seismic communication device is disclosed and described. The device can include a tube, a striker, and an adjustable base. The tube can have a lower portion to support an internal gas pressure and an upper portion which can include a contact anvil oriented at a top end of the tube. The striker can be disposed in the tube and can be displaceable along a length of the tube by the internal gas pressure. The adjustable base can be oriented between the tube and a mine floor and can be extendable and retractable to position the anvil in contact with a mine roof (ceiling), such that the striker impacts the contact anvil when displaced by the internal gas pressure to produce an impact energy wave and the contact anvil transmits the impact energy wave to the strata above the device.

### RELATED APPLICATION

This application claims priority to Chilean Patent Application No. 2829-2011, filed Nov. 11, 2011 and this application claims priority to U.S. Provisional Patent Application No. 61/448,976, filed Mar. 3, 2011 which are each incorporated herein by reference.

### FIELD OF THE INVENTION

The present invention relates generally to seismic communication devices. Accordingly, the invention involves the fields of mechanical engineering and mining engineering.

### BACKGROUND

Underground mining is an often hazardous endeavor that sometimes results in miners trapped deep beneath the surface of the earth. Communication with the trapped miners is difficult, if not impossible, via radio or other common communications means. Phone and other electrical power lines can be severed or create potentially hazardous ignition sources. The miners may have little or no electrical power to operate a communication device. Additionally, there can be flammable gases and/or dust underground near trapped miners. As such, conventional communication devices may pose a risk for ignition and limited electrical power may preclude use of such devices.

### SUMMARY

A portable seismic communication device is disclosed, which can be used by trapped miners to communicate to rescuers. The device can typically be non-electrically operated and can be made of non-sparking materials. The device can comprise a tube having a lower portion to support an internal gas pressure and an upper portion which includes a contact anvil oriented at a top end of the tube. The device can also comprise a striker disposed in the tube that is displaceable along a length of the tube by the internal gas pressure. Additionally, the device can comprise an adjustable base oriented between the tube and a mine floor. The adjustable base can be extendable and retractable to position the anvil in contact with a mine roof (ceiling), such that the striker impacts the contact anvil when displaced by the internal gas pressure to produce an impact energy wave and the contact anvil transmits the impact energy wave to the mine roof.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a view of a portable seismic communication device disposed in an underground mine.

FIG. 2 is a view of a length adjustment mechanism of the portable seismic communication device of FIG. 1.

FIG. 3 illustrates an extension spacer of a portable seismic communication device in accordance with an embodiment of the present disclosure.

FIG. 4 illustrates an extension spacer of a portable seismic communication device in accordance with another embodiment of the present disclosure.

FIG. 5 is a schematic view of the portable seismic communication device of FIG. 1, illustrating an interior of the device and compressed air connections between components of the device.

FIG. 6 is an underground refuge chamber that can be associated with the portable seismic communication device of FIG. 1.

These figures are provided merely for convenience in describing specific embodiments of the invention. Alteration in dimension, materials, and the like, including substitution, elimination, or addition of components can also be made consistent with the following description and associated claims. Reference will now be made to the exemplary embodiments illustrated, and specific language will be used herein to describe the same. It will nevertheless be understood that no limitation of the scope of the invention is thereby intended.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

It must be noted that, as used in this specification and the appended claims, the singular forms “a,” “an,” and “the” include plural referents unless the context clearly dictates otherwise. Thus, for example, reference to “an extension spacer” includes one or more of such items, reference to “length adjustment mechanism” includes reference to one or more of such mechanisms, and reference to “pressurizing” refers to one or more of such steps.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Any steps recited in any method or process claims may be executed in any order and are not limited to the order presented in the claims unless otherwise stated. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

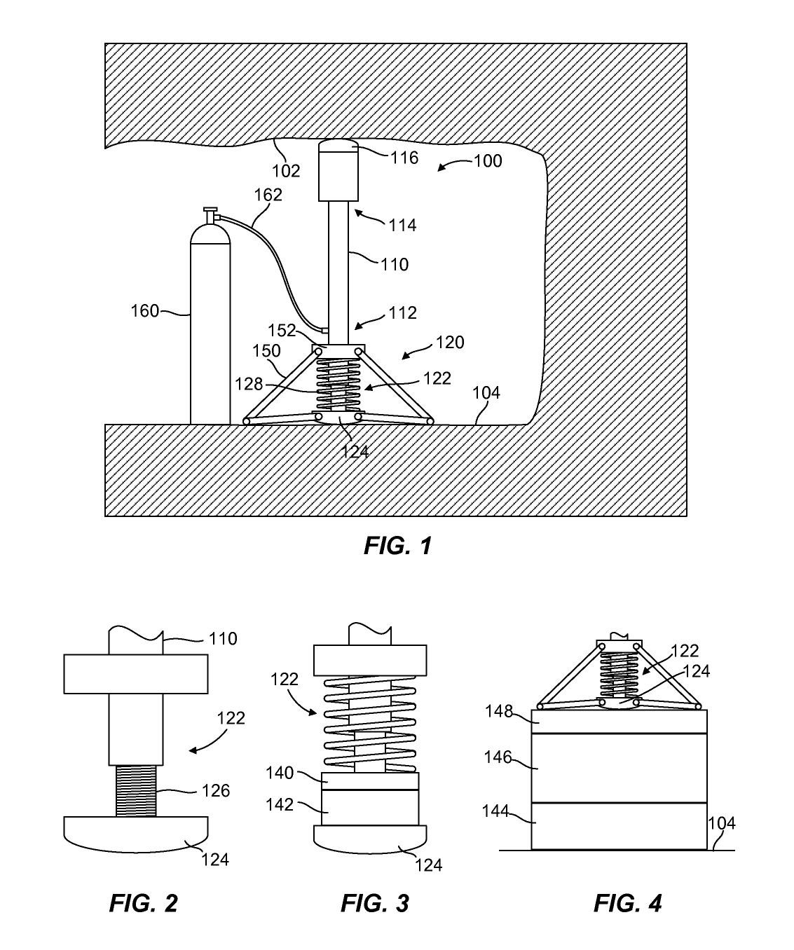

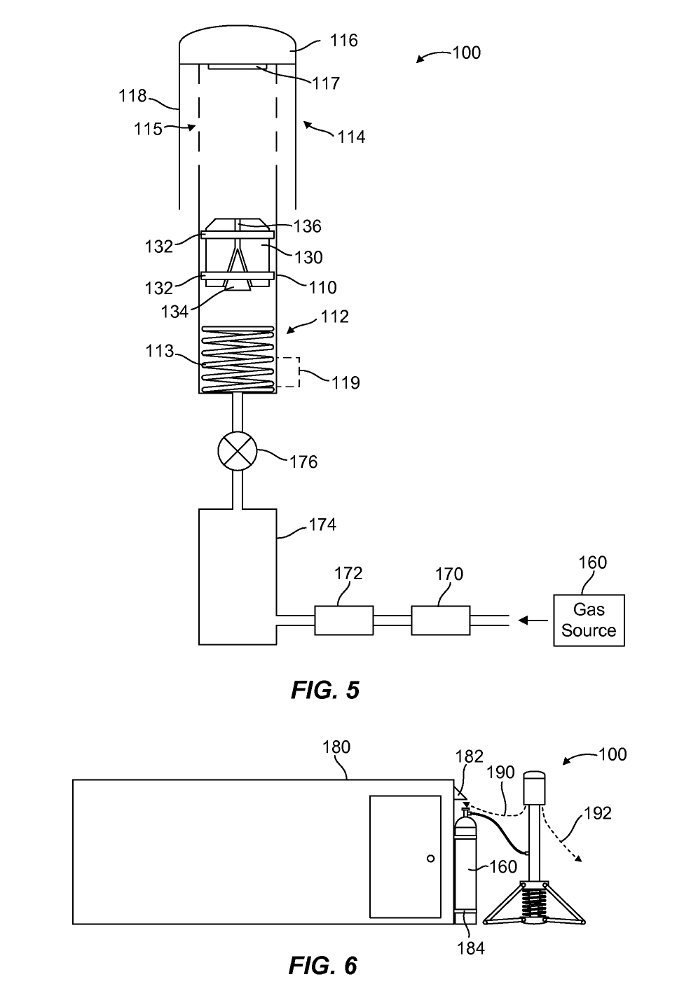

With reference to FIG. 1, illustrated is a portable seismic communication device 100 which can be oriented and leveraged between a mine contacting a mine roof (ceiling) 102 and a mine floor 104. The device 100 can include a tube section 110 and an adjustable base 120. The tube section 110 can have a lower portion 112 which supports an internal gas pressure and an upper portion 114 that can include a contact anvil 116 oriented at a top end of the tube. Although shown in FIG. 5, the device can also include a striker 130 disposed in the tube 110. The striker 130 can be displaceable along a length of the tube 110 by the internal gas pressure.

Referring back to FIG. 1, the adjustable base 120 can be oriented between the tube section 110 and the mine floor 104. The adjustable base 120 can be extendable and retractable to position the anvil 116 in contact with the mine ceiling 102. When the anvil 116 is in contact with the mine ceiling 102, the striker 130 (shown in FIG. 5) can impact the contact anvil 116 to produce an impact energy wave that the anvil transmits to the mine roof (ceiling).

In one aspect, the adjustable base 120 is extendable and retractable by a length adjustment mechanism 122. The length adjustment mechanism 122 can be configured to adjust the height of the anvil 116 within an adjustment range, such as up to about 1 foot. Thus, for example, if the total height of the device 100, i.e. the total stacked height of the adjustable base 120 (length adjustment mechanism 122 fully retracted), the tube 110, and the anvil 116, is less than the height of the mine ceiling 102 by no more than the adjustment range, then the length adjustment mechanism 122 can be effective to extend the adjustable base 120 to position the anvil 116 in contact with the mine roof (ceiling) 102. Additionally, the adjustable base 120 can include a floor plate 124 disposed between the mine floor 104 and the length adjustment mechanism 122 to provide a consistent interface for the length adjustment mechanism 122. The length adjustment mechanism can be integrated with the device.

In one embodiment, shown in FIG. 2, the length adjustment mechanism 122 can comprise a jack screw 126. The jack screw 126 can be coupled to the tube 110 at one end and in contact with the floor plate 124 at the other end. Rotation of the jack screw 126 can increase or decrease the length of the length adjustment mechanism 122. Thus, to prepare the device for use, the jack screw 126 can be rotated to increase length in order to bring the anvil in contact with the ceiling. The jack screw can also be rotated to decrease length in order to create a clearance between the anvil and the ceiling to remove or reposition the device. The jack screw 126 can be coupled to the floor plate 124 (wherein the floor plate 124 would rotate with the jack screw 126) or merely in contact with the floor plate 124

With further reference to FIG. 1, in another embodiment, the length adjustment mechanism 122 can comprise a spring 128. The spring 128 can be coupled to the tube 110 at one end and in contact with the floor plate 124 at the other end. The spring can be configured to exert a force on the floor plate 124 and the tube 110 sufficient to press the anvil 116 into contact with the ceiling 102. In one aspect, a sliding telescoping configuration can be used in place of the jack screw 126, discussed above. However, in another aspect, the spring 128 can be used in conjunction with the jack screw 126. In this case, the spring 128 can relieve at least a portion of the load on the jack screw 126 to reduce the effect of friction between screw threads, which can reduce the amount of force needed to rotate the jack screw 126. Other non-limiting examples of suitable length adjustment mechanisms can include track jacks, hydraulic jacks, cylinder jacks and the like. One commercial example of such includes the Simplex® line of industrial jacks.

Of course, in some cases, the total stacked height of the device 100 (with length adjustment mechanism 122 fully retracted) can be less than the height of the mine ceiling 102 by more than the adjustment range of the length adjustment mechanism 122. In these cases, full extension of the length adjustment mechanism 122 will be ineffective to extend the adjustable base 120 to position the anvil 116 in contact with the mine ceiling 102. Thus, in one aspect, the adjustable base 120 is extendable and retractable by an extension spacer. The height of an extension spacer can be a predetermined length. Extension spacers can be provided in a plurality of different lengths (e.g. 1 foot, 2 feet, 3 feet, etc.) to provide a total extension sufficient to position the anvil 116 in contact with the mine ceiling 102. In other words, a sufficient number and/or combination of extension members can be included to bring the total stacked height of the device 100 to within the adjustment range of the length adjustment mechanism 122. Although mine tunnels and pillar heights can vary, typical mine tunnel heights can range from about 6 feet to about 9 feet. As such, the device 100 can be configured to span this distance as a standalone device, or in connection with suitable spacers.

In one aspect, shown in FIG. 3, an extension spacer, such as extension spacers 140, 142, can be disposed between the floor plate 124 and the length adjustment mechanism 122. The extension spacers can be interlocking blocks. This can provide a consistent interface between the floor plate 124, extension spacer 140, 142, and the adjustment mechanism 122. Thus, the extension spacers 140, 142 can be configured to be stackable or interlocking with one another and with a top side of the floor plate 124, while also providing an interface for the length adjustment mechanism 122.

In another aspect, shown in FIG. 4, an extension spacer, such as extension spacers 144, 146, 148, can be disposed between the floor plate 124 and the floor 104. In this case, the extension spacer 144, 146, 148 can be configured to be stackable or interlocking with a bottom side of the floor plate 124.

Additionally, referring back to FIG. 1, the device 100 can include a lateral support 150 to stabilize the device in an upright orientation. The lateral support 150 can be beneficial when adjusting the height of the device to position the anvil 116 in contact with the mine ceiling 102. The lateral support 150 can be rigidly attached to the tube 110 and/or the adjustable base 120. In one aspect, the lateral support 150 is slidably coupled to the tube 110 and/or the adjustable base 120, such that the lateral support 150 is unaffected by extension and retraction of the adjustable base 120. In this example, extension and retraction of the adjustable base 120 can cause the base 120 and/or tube 110 to slide relative to an interface with the lateral support 150. Such an interface can be a ring or collar 152 disposed about the tube 110 or base 120.

In certain aspects, the lateral support 150 can be removably attachable with the tube 110 and/or base 120. During operation, the lateral support securely retains the device 100 and would not be removable during operation. In one aspect, the lateral support 150 can also be coupled to the floor plate 124 of the adjustable base 120. In another aspect, the lateral support 150 comprises a tripod. The tripod legs can be adjustable lengthwise to allow the device to be upright and substantially vertical on an uneven mine floor. Additionally, the tripod legs can be foldable alongside the tube 110 and/or base 120 to present a more compact form for ease of mobility. Most often, the device 100 is left in place for extended periods of time. However, mobility can be desirable to allow the device to be repositioned near current work locations within a mine.

The device can also include a gas source 160 fluidly coupled to the tube 110. A fluid connection 162 can be provided by a rigid tube or by another high pressure conduit, such as by a heavy duty, high pressure hose. The gas source 160 can provide the internal gas pressure to the lower portion 112 of the tube 110 sufficient to displace the striker 130. In one aspect, the gas source 160 comprises a tank having compressed nitrogen or air. Having an air source can also be beneficial to miners trapped with little to no air and can be used to supplement the existing air supply. It should be recognized, however, that other compressed gases, such as oxygen, can be used to provide gas pressure, as well given a suitable environment. In certain aspects, the gas source can comprise a solid propellant gas generator, such as those used to inflate automobile airbags. Generally, any material can be used which produces pressure sufficient to actuate the striker during use, as described in more detail in connection with FIG. 5. Although illustrated external to the device, the gas source and/or associated valve system can be housed within a common housing. For example, a common housing can be used to enclose the gas source and valves, which housing also supports the tube and base.

With reference to FIG. 5, a schematic view of the portable seismic communication device 100 is shown. This configuration of the seismic communication device 100 illustrates an interior of the device and basic high pressure gas connections between components of the device.

The gas source 160 can provide gas at a pressure of up to about 3000 psi. In one aspect, a pressure regulator 170 can be fluidly coupled between the gas source 160 and the tube 110. The pressure regulator 170 can be set at a predetermined pressure such as 50 psi, 100 psi, 200 psi, etc.

Optionally, a flow regulating valve 172 can be fluidly coupled between the gas source 160 and the tube 110. The flow regulating valve 172 can reduce or cut-off gas flow. In one aspect, the flow regulating valve 172 is a burst valve. In another aspect, the flow regulating valve 172 is a throttling valve. Other valves can also be suitable such as, but not limited to, ball valve, check valve, and the like.

The device 100 can also include an expansion chamber 174 fluidly coupled to the gas source 160. The gas chamber 174 can be “downstream” of the pressure regulator 170 and/or the flow regulating valve 172. In other words, the pressure regulator 170 can reduce pressure from the gas source 160 and the flow regulating valve 172 can manage the flow of gas into the expansion chamber 174. Thus, the flow regulating valve 172 can allow gas to enter the expansion chamber 174 at a controlled rate.

The expansion chamber 174 can also be fluidly coupled to the tube section 110. In one aspect, the device 100 can include a release valve 176 fluidly coupled to the expansion chamber 174 and the tube 110 to release gas into the lower portion 112 of the tube 110 from the expansion chamber 174 to propel the striker 130. When the release valve 176 is opened, gas can flow at a high rate from the expansion chamber 174 into the tube 110, propelling the striker 130 toward the anvil 116. In a particular aspect, the release valve 176 is a spring-loaded manual valve to provide for a fast opening of the valve to allow a rapid pressure build-up in the tube to propel the striker 130. In another particular aspect, the release valve 176 is an automatic valve actuated by a predetermined pressure in the expansion chamber 174. As the pressure increases in the expansion chamber 174 to a predetermined value, the automatic valve opens allowing the gas to discharge through to the launch tube. Once the pressure in the expansion chamber 174 decreases to a predetermined value, the automatic valve closes. This allows the pressure to build in the expansion chamber 174 to repeat the cycle. The flow regulating valve 172 can restrict the flow of gas into the expansion chamber 174 while the striker 130 returns to its launch position at a lower portion 112 of the tube 110. The lower portion 112 of the tube 110 can include a spring 113 to cushion the striker 130 as it returns to the launch position.

The striker 130 can be sized to have a sliding but close fit with the interior of the tube 110. This allows the striker 130 to capture the gas released below it for propulsion. In certain aspects, the striker 130 can include at least one pressure seal 132 to reduce a gap between the striker 130 and the tube 110 thereby improving propulsion of the striker 130 by maintaining the internal gas pressure substantially below the striker 130 during an initial phase of propulsion of the striker 130. For example, one or more slip rings can be attached to the striker 130 to allow the striker to move within the tube 110 with close tolerance but effectively form a seal with the tube 110 to entrap the propelling gas. The pressure seal 132 can be configured to minimize friction between the pressure seal 132 and an inner surface of the tube 110. In one aspect, the pressure seal 132 comprises a smooth surface for interfacing with the tube 110. In another aspect, the pressure seal 132 is constructed of a material that when coupled with the material of the tube 110, results in a low friction interface between the pressure seal 132 and the tube 110. Suitable materials for the pressure seal 132 can be non-sparking materials to avoid or reduce chances of triggering explosive events. Non-limiting examples of suitable non-sparking materials for a pressure seal 132 can include polymers or metals, such as Cu—Ni alloys, brass, bronze, copper beryllium alloys, aluminum alloys, titanium, and the like.

The close fit between the striker 130 and the interior of the tube 110 can result in an “air cushion” below the striker 130 as it moves back toward the lower portion 112 of the tube 110 to its launch position. The air cushion can inhibit the movement of the striker 130, which can be undesirable for timing of the next launch of the striker 130. For example, it may be desirable to have three striker 130 blows at three second intervals separated by a pause and then two striker 130 blows at three second intervals. This could communicate that there are two survivors or some other message.

Thus, in certain aspects, the device 100 can also include a retraction valve that closes when subjected to the internal gas pressure in the tube 110 for launching and that opens when not subjected to the internal gas pressure for returning the striker 130 to the launch position. The internal pressure is used to propel the striker 130 toward the contact anvil 116 and the internal pressure is dissipated through the retraction valve to allow the striker 130 to return to its initial position.

In one aspect, the striker 130 includes a retraction valve 134. For example, the retraction valve 134 can be an integral component of the striker 130. In this case, the retraction valve 134 can seal a passage way 136 in the striker 130 when high-pressure gas is introduced into the launch tube 110. The retraction valve 134 will remain closed due to the high pressure while the striker 130 travels toward the anvil 116. Upon striking the anvil 116, the retraction valve 134 opens due to the absence of the high pressure, which allows the striker 134 to fall toward its initial position expelling air (or gas) in the tube 110 through the passage way 136 in the striker 130 as it travels back to its original position.

In another aspect, a retraction valve 119 is associated with the lower portion 112 of the tube 110. In this case, the retraction valve 119 operates as discussed above, but the retraction valve 119 allows air (or gas) in the tube 110 to escape the tube 110 through a tube wall instead of through a passage way in the striker 130. Of course, there is no limit to the amount or location of the retraction valves and retraction valves may be associated with both the striker 130 and the tube 110.

The size and mass of the striker 130 can affect desired launch pressure. The mass of the striker 130 can also affect the seismic signal propagation distance and strength. However, as a general guideline strikers from about 5 lbs to about 10 lbs may provide detectable signals over distances of 2000 feet or more, depending on the specific formation characteristics. Strikers made of non-sparking materials can be useful to avoid or reduce chances of triggering explosive events. Non-limiting examples of suitable non-sparking materials can include Cu—Ni alloys, brass, bronze, copper beryllium alloys, aluminum alloys, titanium, and the like.

In another aspect, the upper portion 114 of the tube 110 includes a vent 115. The vent 115 can allow air in the tube 110 above the striker 130 and displaced by the striker 130 to exit the tube 110 as the striker 130 moves toward the anvil 116. The vent 115 can also be used to allow the gas used to propel the striker 130 to dissipate after the internal pressure has propelled the striker 130 into the anvil 116. The vent 115 can include one or more openings in a tube wall sufficient to allow the air or gas to escape the tube 110. The vent 115 can be located at an upper portion 114 of the tube 110 near the anvil 116 or the vent 115 can be located at a lower position in the tube 110. Regardless of where the vent 115 is located or how many openings are included, the vent 115 can allow a sufficient internal pressure to build up in the tube 110 to propel the striker 130 with enough force to cause the striker 130 to impact the anvil 116 and send an energy wave to the strata above the mine opening. The vent 115 can be open apertures or can be one-way relief valves. One-way valves can prevent debris or other undesirable materials from entering the launch tube 110.

During operation, gases exiting the tube 110 via the vent 115 can be at a high velocity due to the internal pressure that propels the striker 130. Thus, in a particular aspect, the upper portion 114 of the tube 110 includes a blast shield 118 to deflect gas from the vent 115 in a predetermined direction. The blast shield 118 can divert gases away from where a user's face may be during operation of the device 100. For example, the blast shield 118 can be a cylinder disposed about the tube 110 and spaced therefrom in the vicinity of the vent 115 and attached to the upper portion 114 of the tube 110. This arrangement can divert gases from the vent 115 toward the ground. In another aspect, individual openings of the vent 115 can include a louver to direct the flow of the gas as it exits the vent 115.

The contact anvil 116 can have a slightly curved upper surface. The anvil 116 can be made of aluminum, steel or any other appropriate material. The curved upper surface can provide increased contact with the roof or ceiling 102 of the mine. An optional couplant may be used between the anvil 116 and roof 102 to improve transmission of energy into the strata. For instance, fast setting epoxy may be used to fill in irregularities in the roof 102. Further, the surface of the anvil 116 can be optionally coated to prevent the couplant from bonding the anvil 116 to the roof 102. Additionally, the anvil 116 can include a strike plate 117 to receive impact from striker 130. In one aspect, the strike plate 117 comprises a non-sparking material. The launch tube 110 can also be made of non-sparking material, such as stainless steel or mild steel with an inner bronze sleeve. Such materials can reduce or eliminate rusting of the inner surface of the tube 110 and more importantly, prevent sliding or impacting metal from creating sparks. The striker 130 can be made of high-strength steel. In one example, the striker 130 has approximate dimensions of about 4 inches in diameter by about 8 inches long.

With reference to FIG. 6, and continued reference to FIGS. 1-5, illustrated is an emergency underground refuge chamber 180. The gas source 160 can be installed near such a chamber. In one aspect, the gas source 160 can be attached to an outer wall of the chamber 180 to maintain the gas source 160 in a stable position in close proximity to the refuge chamber 180 and survivors. In case of a caved passage way, where oxygen or air is needed by survivors, a supply of compressed air would be an added benefit of the device 100. In one aspect, the air used to propel the striker 130 can be directed 190 to the chamber 180 for use by survivors inside. The expelled air can be directed to the chamber 180 merely by being in close proximity to a vent 182 of the chamber 180 or the expelled air can be directed into the chamber 180 by a pipe or tube. Air may also be dispersed 192 into the environment surrounding the device 100 to provide additional oxygen for survivors in the vicinity of the device 100 that may be operating the device 100. In one alternative, the portable seismic communication device 100 can be permanently or removably attachable to the refuge chamber 180, such as with brackets or bands 184. Control mechanisms of valves or actuators for the device 100, such as switches or levers, can be located inside or near the refuge chamber 180. As such, the communication device 100 can be actuated and/or monitored from the refuge chamber 180.

It is to be understood that the above-referenced embodiments are illustrative of the application for the principles of the present invention. Numerous modifications and alternative arrangements can be devised without departing from the spirit and scope of the present invention while the present invention has been shown in the drawings and described above in connection with the exemplary embodiment(s) of the invention. It will be apparent to those of ordinary skill in the art that numerous modifications can be made without departing from the principles and concepts of the invention as set forth in the claims.

What is claimed is:

1. A portable seismic communication device, comprising:
a tube having a lower portion to support an internal gas pressure and an upper portion which includes a contact anvil oriented at a top end of the tube;
a striker disposed in the tube that is displaceable along a length of the tube by the internal gas pressure; and
an adjustable base oriented between the tube and a mine floor, the adjustable base being extendable and retractable to position the anvil in contact with a mine roof, such that the striker impacts the contact anvil when displaced by the internal gas pressure to produce an impact energy wave and the contact anvil transmits the impact energy wave to the strata above the device.

2. The device of claim 1, wherein the adjustable base is extendable and retractable by a jack screw.

3. The device of claim 1, wherein the adjustable base is extendable and retractable by a spring.

4. The device of claim 1, wherein the adjustable base is extendable and retractable by an extension spacer.

5. The device of claim 1, further comprising a lateral support to stabilize the device in an upright orientation.

6. The device of claim 1, wherein the upper portion of the tube includes a vent to allow the internal gas pressure to dissipate.

7. The device of claim 8, wherein the upper portion of the tube includes a blast shield to deflect gas from the vent in a predetermined direction.

8. The device of claim 1, wherein the contact anvil includes a strike plate to receive impact from the striker.

9. The device of claim 8, wherein the strike plate comprises a non-sparking material.

10. The device of claim 1, further comprising a retraction valve that closes when subjected to the internal gas pressure and that opens when not subjected to the internal gas pressure, such that the internal pressure is used to propel the striker toward the contact anvil and the internal pressure can be dissipated through the retraction valve after the striker impacts the contact anvil allowing the striker to return to an initial position.

11. The device of claim 10, wherein the striker includes the retraction valve.

12. The device of claim 10, wherein the retraction valve is associated with the lower portion of the tube.

13. The device of claim 1, wherein the striker includes a pressure seal to reduce a gap between the striker and the tube thereby improving propulsion of the striker by maintaining the internal gas pressure substantially below the striker during an initial phase of propulsion of the striker.

14. The device of claim 1, further comprising a gas source fluidly coupled to the tube to provide the internal gas pressure to the lower portion of the tube sufficient to displace the striker.

15. The device of claim 14, wherein the gas source comprises a tank having compressed nitrogen or air.

16. The device of claim 14, further comprising an expansion chamber fluidly coupled to the tube and the gas source.

17. The device of claim 16, further comprising a flow regulating valve fluidly coupled to the expansion chamber and the gas source to allow gas to enter the expansion chamber at a controlled rate.

18. The device of claim 17, wherein the flow regulating valve is a throttling valve.

19. The device of claim 16, further comprising a release valve fluidly coupled to the expansion chamber and the tube to release gas into the lower portion of the tube from the expansion chamber to propel the striker.

20. The device of claim 19, wherein the release valve is an automatic valve actuated by a predetermined pressure in the expansion chamber.
